(19) United States
(12) Patent Application Publication
(10) Pub. No.: US 2004/0200514 A1
(43) Pub. Date: Oct. 14, 2004

(54) Flushing system for a clogged drain

(76) Inventor: Dennis Leung Lee, San Leandro, CA (US)

Correspondence Address: DENNIS LEE, 1155 DUZMAL AVE., SAN LEANDRO, CA, 94579, US

(21) Appl. No.: 10/760,792

(22) Filed: Jan. 20, 2004

Related U.S. Application Data
(60) Provisional application No. 60/441,747, filed on Jan. 21, 2003.

(51) Int. Cl. B08B 9/02

(52) U.S. Cl. 134/166 R; 134/169 R; 134/169 C; 134/183

(57) ABSTRACT

A flushing system is used to clean and/or clear clogged sinks, waste pipes, and/or toilets. It consists of the following components: a control nozzle, a drain attachment, a toilet attachment, foot pedal liquid pump, and a water hose for connecting these components to function as a system. Since the flushing system utilizes the application of the liquid pressure principle, it is required to be connected to a pressurized liquid source when the user chooses not to use the foot pedal liquid pump. An example of a pressurized liquid source can be a water main. A water nozzle is used as an option to connect between the pressurized liquid source and the drain or toilet attachments to control the liquid flow. A pulsating jet of pressurized liquid can be delivered from the outlet of either the drain or toilet attachment to effectively clear clogged pipes by the opening and closing motion of the water nozzle. This flushing system is flexibly designed so that various configurations can be assembled depending on the application needed and can be used where a water main is not accessible. Each configuration provides ease of use and a more solution than all other patented and currently available solutions. When not in use, the whole flushing system can be conveniently stored inside the foot pedal pump, giving it a very aesthetic appealing look.

Although the present invention has been described with respect to certain embodiments, examples, and applications, it will be apparent to those skilled in the art that various modifications and changes may be made without departing from the invention.

### CROSS-REFERENCE TO RELATED APPLICATIONS

This application is entitled to the benefits of Provisional Patent Application Ser. No. 60/441,747, filed on Jan. 21, 2003.

### FEDERALLY SPONSORED RESEARCH

None

### SEQUENCE LISTING

None

### BACKGROUND OF INVENTION—FIELD OF INVENTION

This invention relates to the unclogging and cleaning of clogged sinks, waste drains, toilet pipes and toilets.

### BACKGROUND OF INVENTION

Clogged sinks, waste drains, waste pipes and toilets are caused by accumulation of foreign material trapped in its flow path way. Consequently, over time this causes back up in drains, pipes, and toilets. They can be cleared by the following methods: Chemical, mechanical, or hydraulic (liquid pressure). Chemical product such as sodium hypochlorite, sulphuric acid and mechanical devices consisting of plungers and drain snakes, along with inflatable bulbs that use liquid pressure are widely available in the marketplace. Chemical generally either takes an excessive amount of time to be effective and corrosive that is harmful to the environment and results in some damage to waste drainpipes while removing the clog. Mechanical devices like the drain snake can damage sinks and toilets, which requires the user to have some basic knowledge of plumbing to remove fixture that may incur harm from these types of devices. Inflatable bulbs offer little to no control of the liquid pressure and require insertion into the pipe below the waste drain itself hindering the user, thus requiring some knowledge of plumbing for the device to be effective. Plungers with a hollow shaft where pressurized liquid passes through the suction cup are not available in the market, perhaps due to its impracticality as some dwellings have no accessibility to a water main or that the faucet supplies to a weak liquid pressure source.

Patent Reference List

Flood, in U.S. Pat. No. 2,781,166

Rankovic, in U.S. Patent No, 6,035,455

Lundman, in U.S. Pat. No. 3,714,951

Tesh, in U.S. Pat. No. 3,792,708

Tharp, in U.S. Pat. No. 2,036,614

Brown, in U.S. Pat. No. 2,336,592

Allen, in U.S. Pat. No. 4,622,702

Li, in U.S. Pat. No. 4,320,539

Davenport, in U.S. Patent No, 5,020,166

Flood, in U.S. Pat. No. 2,781,166, foot pump is used to supply air pressure. It is not designed to hold liquid nor does it have the capability to fill with water.

Rankovic, in U.S. Patent No, 6,035,455, Portable Power Plumbing Plunger, is a stand-alone device. It is complicated and difficult to operate and requires the user to have both hands to operate the device, one to hold the device to the drain hold to create a liquid tight seal while the other hand needs to pump the handle to apply force to create the needed liquid pressure. The manufacturing step for this device is more involved than the flushing system.

Lundman, in U.S. Pat. No. 3,714,951, Conduit Flusher, (1973) and Tesh, in U.S. Pat. No. 3,792,708, Fluid Flow Director, (1974) require the device be inserted into the pipe or an adaptor. It functions by expanding the bulb to prevent back flow before liquid is fully channeled to clear and clean the clog. It does not have control of liquid pressure and flow.

Tharp, in U.S. Pat. No. 2,036,614 (1936), Drain Pipe Cleaner is designed with a flexible hos and needs to connect to a faucet and offers very little griping area to press the head to the mouth of the drain The head is not detachable and offers no option to control the liquid pressure.

Brown, in U.S. Pat. No. 2,336,592 (1943), Drain Cleaner, is designed with a suction ring and can be operated without a liquid source. It has a side arm for liquid source as well as a handle to press to device against the mouth of the drain.

Li, in U.S. Pat. No. 4,320,539, Drain Clearing Device, discloses an elongated pipe with a manually operated plunger valve that activates a flow of pressurized water. A side arm, branching from and communicating with the pipe, is attached to a source of pressurized liquid by a male means of connection.

Torti, in U.S. Patent No, 4,768,237, Toilet Plunger, discloses a tubular handle elements attached to a mushroom-shaped cup having a check valve to prevent a backflow of water. The female receptors on the opposite ends of the handle allow the connection to a pressurized source of water.

Davenport, in U.S. Patent No, 5,020,166 Multipurpose Liquid Pressure Plunger is designed to a have a resilient cone-shape cup, a rigid handle and an adjustable valve.

In conclusion, insofar as of all researches done and prior arts, no unclog systems, solutions, or devices formerly developed provide the versatile and ease of use options to clear and clean clogged drain and are available in the market. All configurations of the present invention for a clogged drain allow the user to have easy usage of the system while providing an effective solution to their clogged problems. This invention is a complete solution for clogged sinks, waste drain, waste pipes, and toilets.

### SUMMARY

The invention consists of various key components, that when connected either independently or in a stand alone system configuration to a pressurized liquid source, (i.e., water main) effectively removes clogs that may occur in waste drains, waste line plumbing, and sanitary toilets. Accordingly several objects and advantages of the invention are to provide ease of use, timely removal of the clog, and direct control of the liquid pressure and flow. Still further objects and advantages will become apparent from a study of the following description and the accompanying drawings.

### DETAILED DESCRIPTION

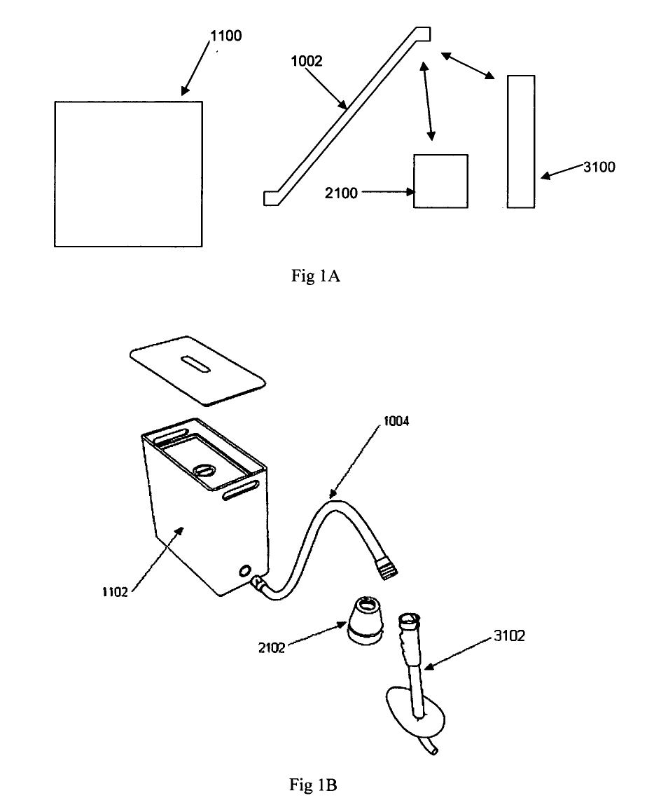

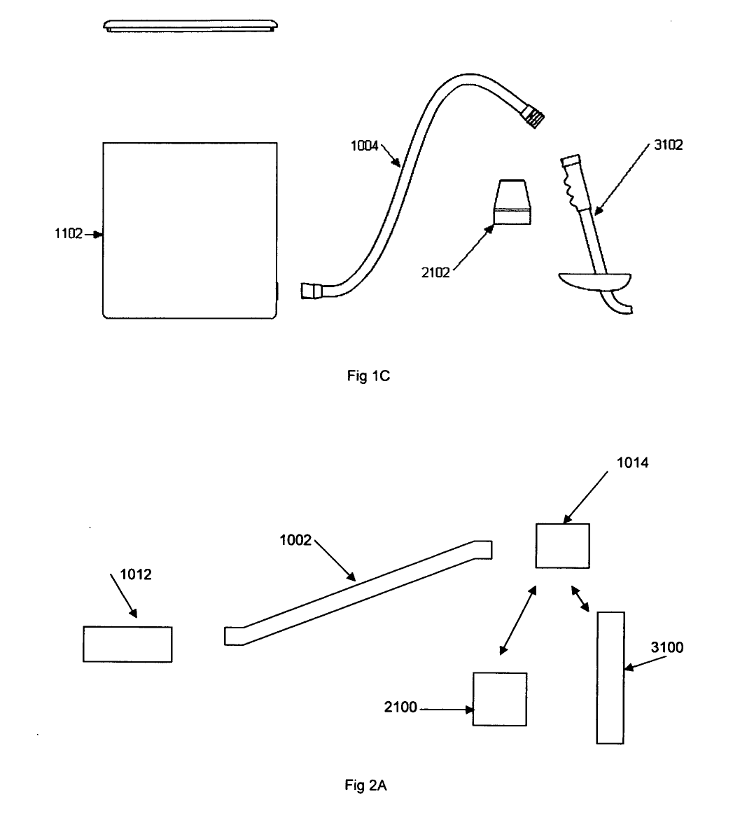

FIG. 1A. Block diagram of the flushing system connecting to a manual operated pressurized liquid device 1100.

FIG. 1B. Perspective view of an embodiment of the present invention connected to a foot pedal liquid pump 1102.

FIG. 1C. Side view of the embodiment as shown in FIG. 1B connected to a foot pedal liquid pump 1102.

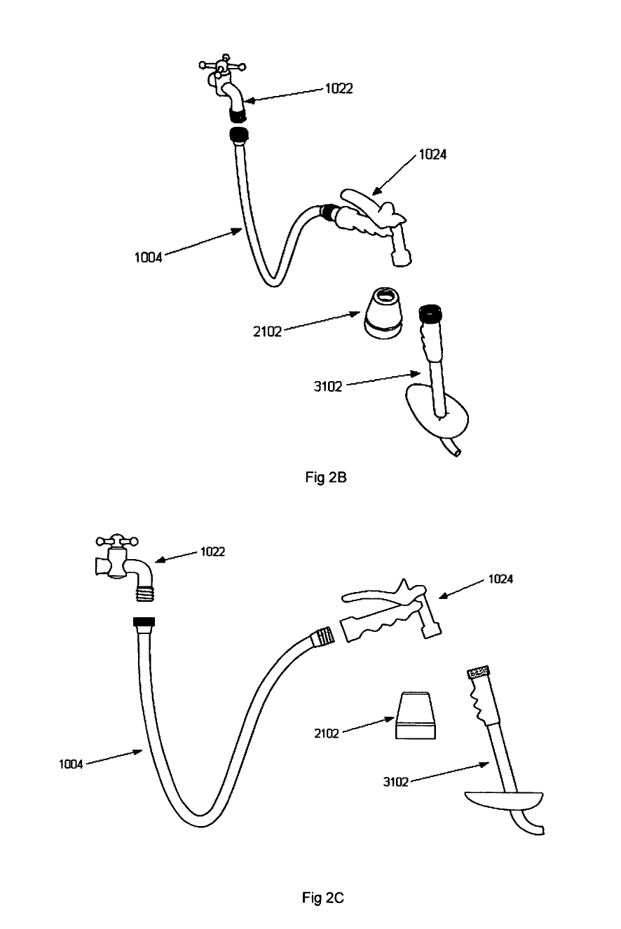

FIG. 2A. Block diagram of the present invention connected to a pressurized water main 1012.

FIG. 2B. Perspective view of an embodiment of the present invention connected to a water main 1012 via a spigot 1022

FIG. 2C. Side view of the embodiment of the present invention connected to a water main 1012 via a spigot 1022

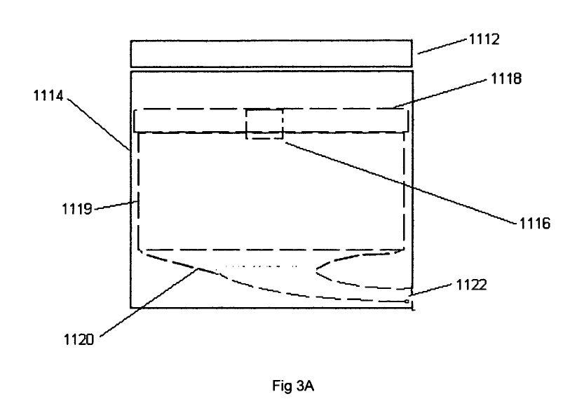

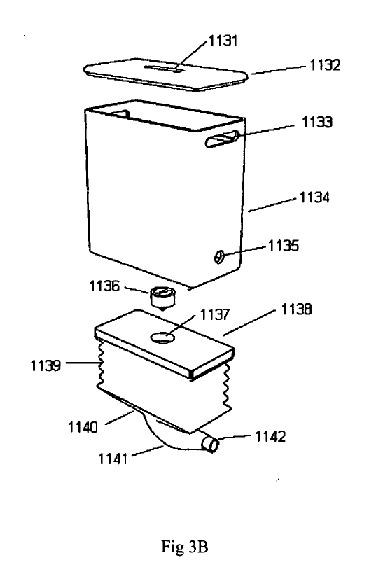

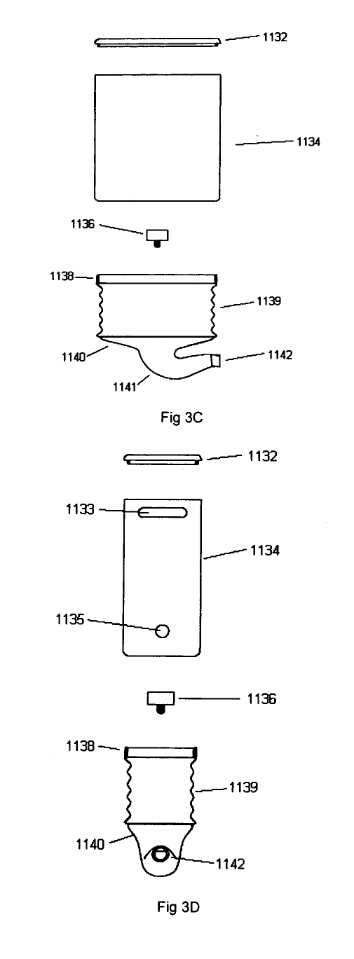

FIG. 3A. Side view of a manual operated pressurized liquid device 1100 of the present invention

FIG. 3B. Perspective view of an embodiment of a foot pedal liquid pump 1102 assembly

FIG. 3C. Side (length) view of the embodiment of the foot pedal liquid pump 1102 assembly as shown in FIG. 3B.

FIG. 3D. Side (width) view of the embodiment of the foot pedal liquid pump 1102 assembly as shown in FIG. 3B

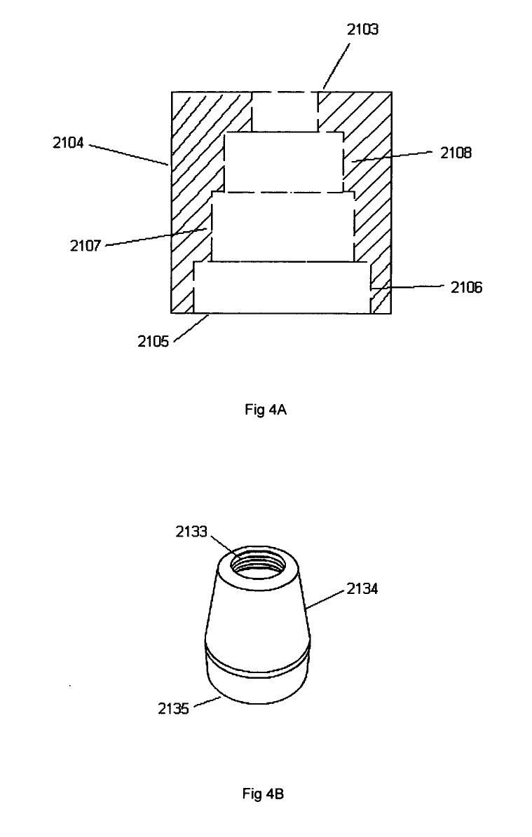

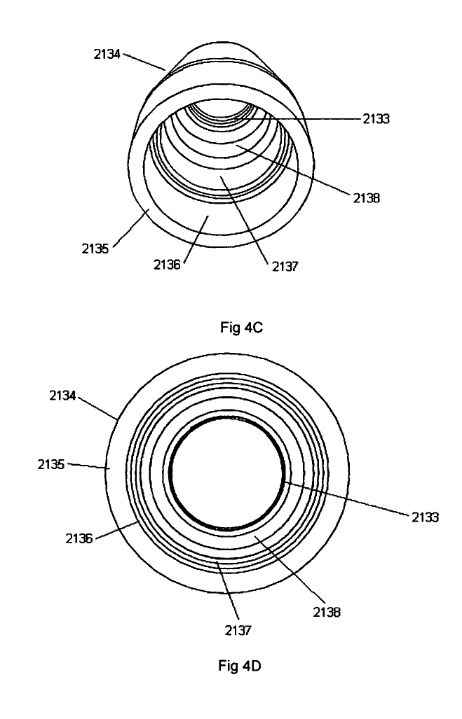

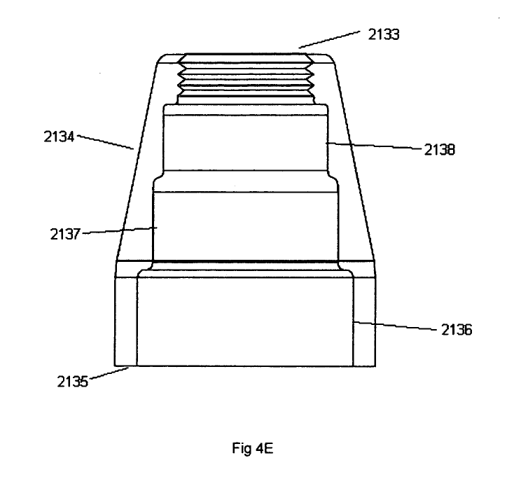

FIG. 4A. Cross-sectional view of the drain attachment 2100 of the present invention.

FIG. 4B. Perspective top view of an embodiment of the drain attachment 2102

FIG. 4C. Perspective bottom view of the embodiment of the drain attachment 2102 as shown in FIG. 4B

FIG. 4D. Bottom view of the embodiment of the drain attachment 2102 a shown in FIG. 4B.

FIG. 4E. Side view of the embodiment of the drain attachment 2102 as shown in FIG. 4B

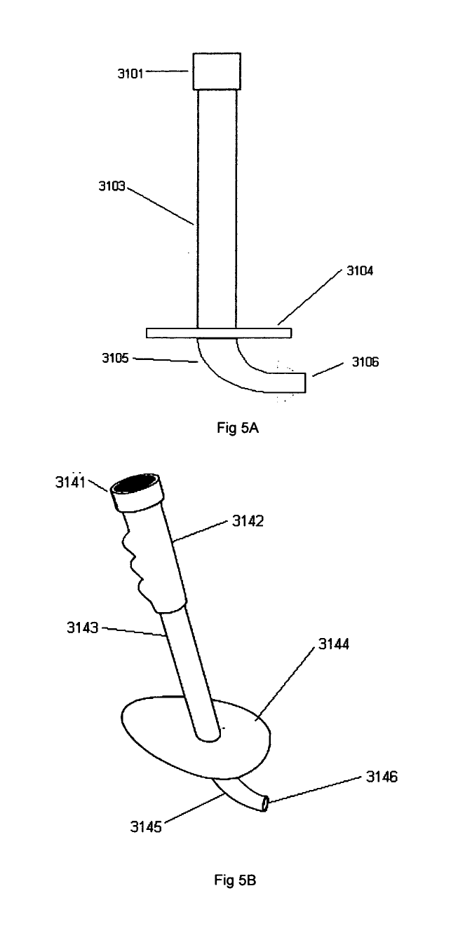

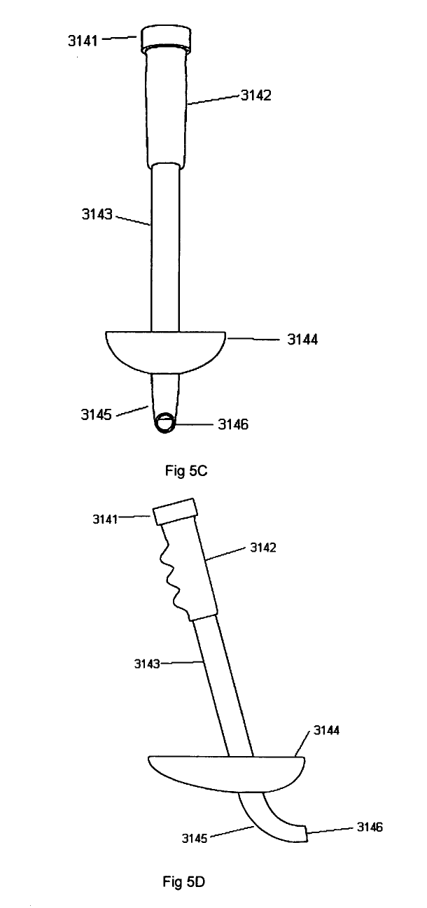

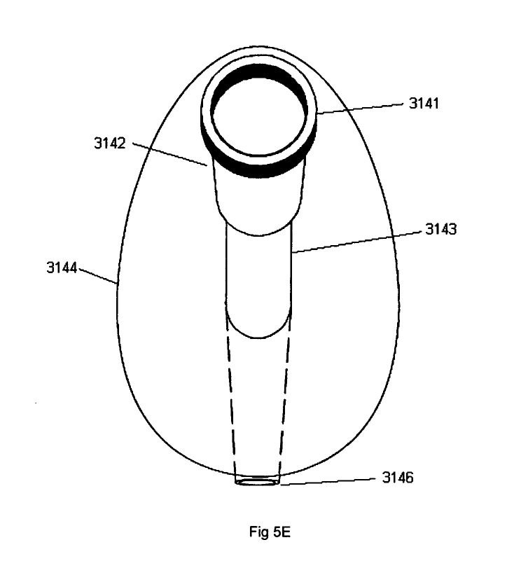

FIG. 5A. Side view of the toilet attachment 3100 as referenced in FIGS. 1A and 2A

FIG. 5B. Perspective view of an embodiment of the toilet attachment 3102

FIG. 5C. Front view of the embodiment of the toilet attachment 3102 as shown in FIG. 5B

FIG. 5D. Side view of the embodiment of the toilet attachment 3102 as shown in FIG. 5B

FIG. 5E. Top view of the embodiment of the toilet attachment 3102 as shown in FIG. 5B

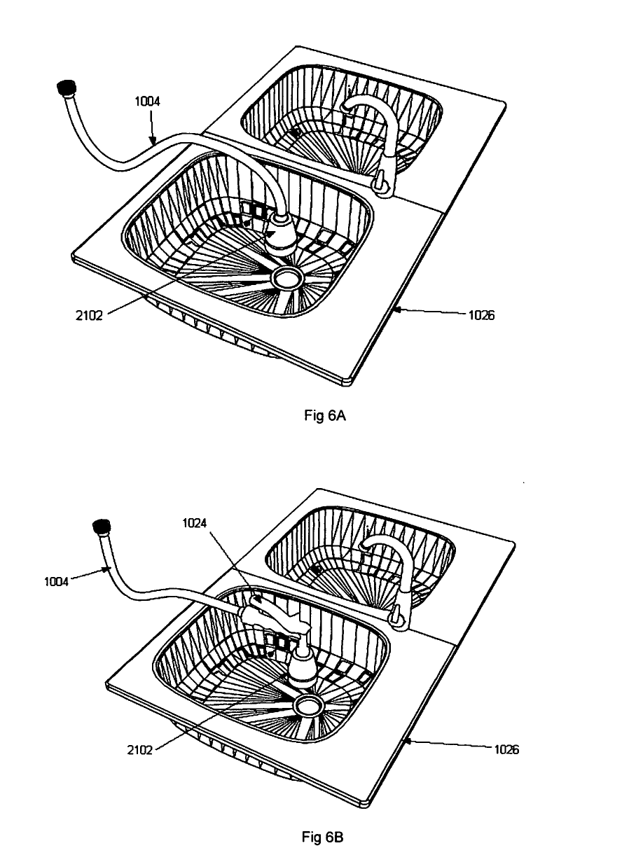

FIG. 6A. Perspective view to clear clogged drain with the foot pedal liquid pump configuration.

FIG. 6B. Perspective view to clear clogged drain with the water main connection via a spigot 1022.

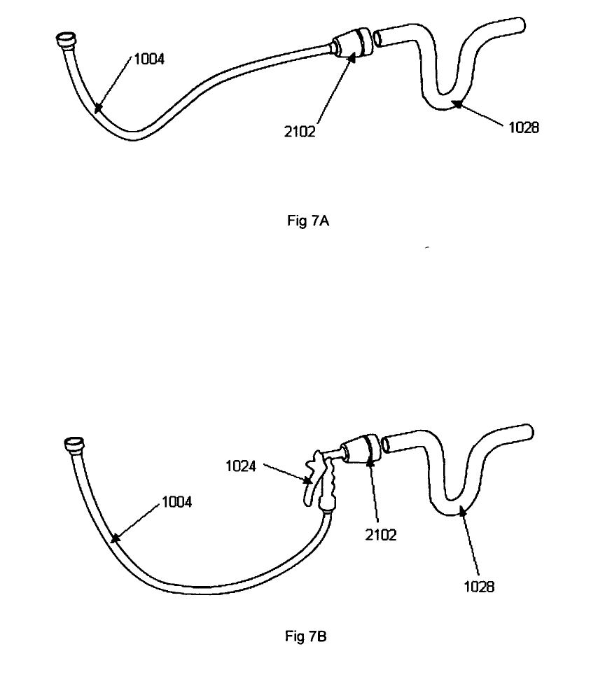

FIG. 7A. Perspective view to clear clogged pipe with the foot pedal liquid pump 1102 configuration.

FIG. 7B. Perspective view to clear clogged pipe with the water main connection via a spigot 1022.

FIG. 8A. Perspective view to clear clogged toilet with the foot pedal liquid pump 1102 configuration.

FIG. 8B. Perspective view to clear clogged toilet with the water main connection via a spigot 1022.

### REFERENCE NUMERALS

1002. water hose

1004. water hose

1012. water main

1014. water nozzle

1022. spigot

1024. water nozzle

1026. kitchen sink

1028. drainpipe

1030. toilet

1100. manual operated pressurized liquid device

1102. foot pedal liquid pump

1112. case cover

1114. casing

1116. cap

1118. foot stepping plate

1119. water bag

1120. pump base

1122. pump outlet

1131. cover longitudinal through-hole

1132. case cover

1133. case handle through-hole

1134. case

1135. outlet hole

1136. cap

1137. cap hole

1138. foot stepping plate

1139. water bag

1140. pump base

1141. base taper

1142. outlet connector

2100. drain attachment

2103. inlet receptor

2104. drain attachment body

2105. drain attachment outlet

2106. first foremost ring

2107. second foremost ring

2108. top ring

2102. drain attachment

2133. drain attachment inlet

2134. drain attachment body

2135. drain attachment outlet

2136. base inner hollow ring

2137. middle inner hollow ring

2138. top inner hollow ring

3100. toilet attachment

3101. toilet attachment inlet

3102. toilet attachment

3103. tubular shaft

3104. flexible anti-splash

3105. bent

3106. toilet attachment outlet

3141. toilet attachment inlet

3142. handle

3143. tubular shaft

3144. flexible anti-splash

3145. bent

3146. toilet attachment outlet

FIG. 1A is a block diagram of the present invention for the application to clear or clean a clogged drain. This block diagram illustrates the general concept of component connections of the invention. The manual operated pressurized liquid device 1100 connects to either a drain attachment 2100 or a toilet attachment 3100 via a flexible water hose 1002. The present invention when configured properly can generate and supply its own pressurized liquid for the application to clear and clean a clog.

FIG. 1B is a perspective view of an embodiment in accordance with the present invention taken from the user's right side. It consists of a foot pedal liquid pump 1102, a drain attachment 2102, a toilet attachment 3102, and a water hose 1004.

FIG. 1C is the side view of the embodiment as shown in FIG. 1B.

FIG. 2A is a block diagram of the present invention for a clogged drain with accessibility to a water main via a spigot connection. This block diagram illustrates the general concept of component connections of the invention. The drain attachment 2100 or the toilet attachment 3100 connects to the water main 1012 via the water hose 1002 and the water nozzle 1014.

FIG. 2B is a perspective view of an embodiment of the present invention taken from the user's right side when a configuration is connected to a spigot. The water nozzle 1022 can either be connected to a drain attachment 2102 or a toilet attachment 3102.

FIG. 2C is the side view of the embodiment as shown in FIG. 2B.

FIG. 3A is a side view of an embodiment of a manual operated pressurized liquid pump 1100. The manual operated pressurized liquid pump 1100 can be made in different shapes, sizes, materials, and forms providing the following mininum features are met: The device preferably has the capacity to store liquid and when compressed could generate the needed liquid pressure and flow for the application to clear and clean clogs. When the inner liquid bag 1119 is compressed, it allows storage space for other components of the said system. As referred in FIG. 3A, the foot pedal liquid pump 1100 could consist of the following components: a case cover 1112, a casing 1114, a cap 1116, a foot stepping plate 1118, a liquid bag 1119, a pump base 1120, and an outlet connector 1122. The foot pedal liquid pump can be designed with a carrying handle.

FIG. 3B is an exploded assembly view of one of the embodiment as show in FIG. 1b of a foot pedal liquid pump 1102. Centered on the case cover 1132, is a cover longitudinal through-hole 1131. Fingers can be inserted through the through-hole to lift the case cover 1132 to access to the inner housing. Through-hole can be circular, rectangular, or concave without a cut-out. On the wide sides of the casing 1134 are casing handle through-holes 1133. These casing handle through-holes are intended for the purpose of lifting and carrying of the foot pedal liquid pump 1102. A circular outlet hole 1135 is located on the bottom of the wide side of the casing 1134. This is center and mate with the outlet connector 1142 where a water hose 1004 can connect to. Inside the inner housing is a water bag 1139. Top of the water bag. 1139 is a foot stepping plate 1138. A cap hole 1137 is centered on the foot stepping plate where a cap 1136 fits flush to the foot stepping plate when closed.

FIG. 3C is the long-side side view of the embodiment as shown in FIG. 3B.

FIG. 3D is the wide-side side view of the embodiment as shown in FIG. 3B.

FIG. 4A is a cross-sectional view as shown in FIG. 1A of the drain attachment 2100. The drain attachment 2100 can be made in different shapes, sizes, materials, and forms providing that it has the ability to channel the pressurized liquid from the drain attachment inlet 2103 to the drain attachment outlet 2105 to clear the clog. The interior of the body can be of concentric hollow rings, minimum two different diameters inside with the first foremost ring 2106 closes to the largest opening, second foremost ring 2107 relative to the first ring 2106, and so forth. The numbers of hollow rings can vary. The hollow rings fit standard pipes to provide liquid tight seal when pressed against an opening of the standard pipes so when pressurized liquid flows through said device; it is fully channeled to the clog.

FIG. 4B is a perspective view of an embodiment of the drain attachment 2102 looking top down. The drain attachment inlet 2133 screws to either a water hose 1004 or a water nozzle 1024 that has a standard size thread receptor.

FIG. 4C is a perspective view of an embodiment of the drain attachment 2102 looking from the bottom.

FIG. 4D is the bottom view of the embodiment of the drain attachment 2102 as shown in FIGS. 4B and 4C.

FIG. 4E is the side view of the drain attachment 2102 as shown in FIGS. 4B and 4C.

FIG. 5A is a side view of a general toilet attachment 3100 as shown in FIG. 1A. The toilet attachment 3100 can be made in different shapes, sizes, and forms providing that it has an inlet, an outlet, and a flexible anti-splash. The structure of the toilet attachment can have the following features: a toilet attachment inlet 3101, a tubular shaft 3103, a flexible anti-splash 3104, a bent 31055, and a toilet attachment outlet 3106. The toilet attachment inlet 3101 is a receptor connector for the incoming pressurized fluid. The tubular shaft 3103 acts as a conduit for the pressurized liquid to flow through and out to the toilet attachment outlet 3106. The bent 3105 further helps to channel the liquid flow to effectively clear the clog. The flexible anti-splash prevents liquid backflow or any back splash.

FIG. 5B is a perspective view of one of the embodiments of a drain attachment of the toilet attachment 3102 looking from the user's right side.

FIG. 5C is the front view of the embodiment of the toilet attachment 3102 as shown in FIG. 5B.

FIG. 5D is the side view of the embodiment of the toilet attachment 3102 as shown in FIG. 5B.

FIG. 5E is the top view of the embodiment of the toilet attachment 3102 as shown in FIG. 5B.

FIG. 6A is a perspective view of an embodiment of the present invention configuration by which method used to clear a clogged kitchen sink 1026.

FIG. 6B is a perspective view of an embodiment of the present invention configuration by which method with a water nozzle 1024 used to clear a clogged kitchen sink 1026.

FIG. 7A is a perspective view of an embodiment of the present invention configuration by which method to clear a clogged drain pipe 1028.

FIG. 7B is a perspective view of an embodiment of the present invention configuration by which method with a water nozzle 1024 to clear a clogged drain pipe 1028.

FIG. 8A is a perspective view of an embodiment of the present invention configuration by which method to clear a clogged toilet 1030.

FIG. 8B is a perspective view of an embodiment of the present invention configuration by which method with a water nozzle 1024 to clear a clogged toilet 1030.

Operation

The flushing system for a clogged drain assembles and operates in the following manner:

(1) For clogged kitchen sinks, referring to FIG. 6B, the drain attachment 2102 connects to the outlet of the water nozzle 1024 while the inlet of the water nozzle 1024 is connected to a pressurized liquid source. For convenience, the water nozzle 1024 can be omitted as seen in FIG. 6A when the foot pedal liquid pump 1102 is used to supply the pressurized water. The pressurized liquid source can be from a water main 1012 or from a foot pedal liquid pump 1102. Using either of the above mentioned configurations, the user aligns and presses the outlet of the drain attachment center to the drain hole of the sink. As pressurized liquid flows through the drain attachment 2102, said outlet prevents back flow liquid and splash, channeling all pressurized liquid from said attachment through the drain hole. This force breaks the clog and flushes the remnant in the drain pipe that causes the clog.

(2) For a clogged washbowl where a stopper is linked and controlled by a handle and where said stopper needs to be removed when a drain snake (auger) is used, the flushing system can be used in the following manner to unclog the clogged washbowl without the removal of the stopper. Configurations as described in operation (1) can be used. First, the drain hole needs to be kept open with one hand controlling the handle, while the other hand presses the drain attachment 2102 to the drain hole. Since the drain attachment outlet 2135 is bigger than the drain hole of the washbowl, all liquid flow through the drain attachment will channel around the stopper and down the drain hole, which would clear the clog.

(3) For open clogged waste pipes, the same configuration as described in operation (1) is applicable. FIG. 7A shows the configuration without the water nozzle when it is connected to the foot pedal liquid pump 1102. FIG. 7B shows the configuration with the water nozzle 1024 when connecting to a water main via a spigot 1022. The user aligns and presses the outlet of the drain attachment center to the waste pipe. The outlet diameter of the drain attachment is bigger than various standard waste pipes. As the drain attachment outlet 2135 caps the waste pipe, the inner concentric hollow cylinders of the drain attachment fit snuggly to the various standard diameters of the waste pipes, typically 1¼″ and 1½″ in diameters. When the pressurized liquid flows through the drain attachment, said attachment channels all liquid from said outlet through the waste pipe, preventing any liquid back splash. The liquid flow breaks the clog and flushes the remnant through the pipes to the main waste pipe.

(4) For clogged toilets, the toilet attachment connects to the water nozzle outlet while the said inlet is connected to a pressurized liquid source as shown in FIG. 8B. For convenience, the water nozzle 1024 can be omitted as shown in FIG. 8A when the foot pedal liquid pump 1102 is used to supply the pressurized water. The pressurized liquid source can be from a water main 1012 or from a foot pedal liquid pump 1102. To clear clogged (back up) toilets, use the above mentioned assembly and align and press the outlet of the toilet attachment center to the flushing hole of the toilet. When the pressurized liquid is released through the control nozzle, the circular disk made of flexible material of the toilet attachment seals the mouth of the drain hole as it is pressed downward and prevents back flow liquid and splash, channeling all pressurized liquid from the outlet through the flushing hole. This force breaks the clog and flushes the remnant through the pipes to the main waste pipe.

I claim:

1. A flushing system for a clogged drain, comprising:
(a) a channeling device having an inlet and outlet openings and concentric hollow rings, minimum of two different diameters in its interior body with the first foremost ring closes to the largest opening, second foremost ring relative to the first ring and so forth, referenced in the present invention as the drain attachment,
(b) and a elongated channeling device having an inlet, a tubular shaft, a flexible anti-splash, and a bent outlet, referenced in the present invention as the toilet attachment,
(c) a portable liquid pump device fashioned with a collapsible liquid bag within a casing,
(d) means to interconnect said portable liquid pump to said elongated channeling device or said channeling device,
whereby a user can connect said channeling device with said portable liquid pump device via a flexible liquid conduit for the intended application of clearing and cleaning clogged drains and pipes as the said portable liquid pump is capable of storing liquid and producing a pressurized liquid flow,
whereby a user can connect said elongated channeling device with said portable liquid pump device via a flexible liquid conduit for use to clear and clean clogged toilets.

2. The channeling device of claim 1 wherein said inlet is of standard, threaded design and compatible with any standard, threaded source of pressurized water,
whereby a user can connect said elongated channeling device to standard, threaded source of pressurized water.

3. The two concentric hollow rings of the interior body of said channeling device of claim 1 wherein have inner body diameters about 1¼″ and 1½″, respectively, whereby the said 1¼″ hollow ring caps the standard 1¼″ size drain pipe opening, whereby the said 1½″ hollow ring caps the standard 1½″ size drain pipe opening.

4. The outlet of said channeling device of claim 1 wherein has the largest inner hollow ring diameter approximately 2″,
whereby said outlet of said channeling device is larger than standard kitchen drain holes, and the likes.

5. The elongated channeling device of claim 1 wherein the said inlet is of standard, thread design and compatible with any standard, threaded source of pressurized water,
whereby a user can connect said channeling device to standard, threaded source of pressurized water.

6. Said anti-splash shield of said elongated channeling device of claim 1 is fashioned of flexible material and larger than the standard size toilet drain holes,
whereby the said anti-splash shield conforms to and caps said standard toilet drain holes.

7. Said portable liquid pump device of claim 1 wherein the said casing has the capacity for storage of other said components of the present invention and other accessory articles.
